(19) United States
(12) Patent Application Publication
(10) Pub. No.: US 2019/0340939 A1
(43) Pub. Date: Nov. 7, 2019

(54) FACILITATING COMMUNICATION BETWEEN A MOBILE OBJECT AND A REMOTE SYSTEM OVER LONG DISTANCES

(71) Applicant: Microsoft Technology Licensing, LLC, Redmond, WA (US)

(72) Inventors: Amer Aref HASSAN, Kirkland, WA (US); Paul William Alexander MITCHELL, Seattle, WA (US); David Anthony LICKORISH, Sammamish, WA (US)

(21) Appl. No.: 15/970,568

(22) Filed: May 3, 2018

(51) Int. Cl. G08G 5/00; B64C 39/02; G05D 1/10; G05D 1/00; H04W 72/04

(52) U.S. Cl. CPC G08G 5/0069; B64C 39/024; G08G 5/0013; G08G 5/0039; B64C 2201/146; G05D 1/0022; H04W 72/0453; B64C 2201/141; G05D 1/101

(57) ABSTRACT

A method for facilitating communication between a mobile object and a remote system may include obtaining channel information indicating which wireless channels are available in a plurality of locations along a route to be traveled by the mobile object. The channel information may be used to select one or more available wireless channels for communicating with at least one relay station while the mobile object travels along the route. One or more messages may be sent to the remote system via the at least one relay station. Wireless communication between the mobile object and the at least one relay station may occur via the one or more available wireless channels.

### CROSS-REFERENCE TO RELATED APPLICATIONS

N/A

### BACKGROUND

There are many situations in which it may be desirable for a mobile object to be able to communicate with a remote system. For example, consider a drone, which is an aircraft without a human pilot aboard and is sometimes referred to as an unmanned aerial vehicle (UAV). Some drones may be piloted remotely, while other drones are fully autonomous vehicles. An autonomous drone typically communicates with a control system while the drone is in flight.

Drones can be used to perform a variety of tasks that are difficult for humans and other robots. While drones originated mostly in military applications, their use is rapidly expanding to commercial, scientific, and recreational applications. For example, drones have been used for product deliveries, aerial photography, surveying, agriculture, law enforcement, data collection, and surveillance. A drone may be utilized to transport one or more items, such as food, medicine, or other goods. For some applications, autonomous drones travel long distances. In these types of situations, it may be desirable for a drone to be able to maintain regular communication with the control system.

Other examples of mobile objects that may need to communicate with a remote system include other types of UAVs (such as satellites or balloons) as well as unmanned land vehicles, including self-driving cars.

### BRIEF DESCRIPTION OF THE DRAWINGS

FIG. 1 illustrates a relay network including a plurality of relay stations positioned along a route to be traveled by a drone.

FIG. 2 illustrates a drone obtaining channel information indicating which wireless channels are available in various locations along a scheduled route.

FIG. 3 illustrates a drone re-establishing communication with a control system via a relay station.

FIG. 4 illustrates a drone re-establishing communication with a control system via a relay station that is not connected to the Internet.

FIG. 5 illustrates a drone broadcasting a message while flying over a section of a scheduled route that does not include any fixed relay stations but does include a highway.

FIG. 6A illustrates another example of a route to be traveled by a drone.

FIG. 6B illustrates an example showing how a control system may periodically query a white space database on behalf of a drone and communicate query results to the drone using a network of relay stations.

FIG. 7 illustrates a method that may be implemented by a drone to facilitate regular communication between the drone and a control system.

FIG. 8 illustrates a method that may be implemented by a relay station to facilitate regular communication between a drone and a control system.

FIG. 9 illustrates a method that may be implemented by a control system to facilitate regular communication between a drone and the control system.

FIG. 10 illustrates certain components that may be included within a computer system.

FIG. 11 illustrates certain components that may be included within a drone.

### DETAILED DESCRIPTION

The present disclosure is generally related to facilitating communication between a mobile object and a remote system. For purposes of example, some aspects of the present disclosure will be described in relation to a drone that maintains regular communication with a control system as the drone travels along a scheduled route. However, the present disclosure is also applicable to other types of mobile objects that travel long distances, including unmanned objects or vehicles such as satellites, balloons, and self-driving cars.

Some aspects of the present disclosure will be described in relation to autonomous drones, i.e., drones that are capable of flying a predetermined flight route without human intervention. In the discussion that follows, the term “drone” refers to an autonomous drone unless explicitly indicated otherwise.

As indicated above, a drone typically communicates with a control system while the drone is in flight. It is important for the control system to maintain regular communication with the drone. Drones, however, sometimes travel long distances (e.g., hundreds of miles or more). For example, drones may be used to deliver packages to remote locations. If a drone is flying a predetermined route over a long distance, it may be difficult to maintain regular communication between the drone and a control system.

A drone may be equipped with a cellular radio in order to facilitate communication with a control system via one or more cellular networks. However, a drone that is traveling hundreds of miles in rural areas may be outside the range of any cellular networks for long periods of time. Also, the use of cellular radios would require a subscription to a cellular network. This can be expensive, especially for a fleet of many drones. Another alternative would be to facilitate communication between a drone and a control system through the use of satellites. However, satellite radios are expensive and they significantly increase the weight of a drone.

Some aspects of the present disclosure are related to improved techniques for facilitating regular communication between a drone and a control system while the drone is in flight. In some implementations, white space frequencies may be utilized to facilitate such communications.

As used herein, the term “white space frequencies” refers to frequencies that may be made available for unlicensed use at locations where the spectrum is not being used by licensed services. In many countries, significant portions of the radio spectrum are becoming free as a result of technical changes. For example, the transition to digital television has freed up significant portions of the radio spectrum that used to be allocated for television broadcasting. The abandoned television frequencies are in the ultra high frequency (UHF) band as well as the very high frequency (VHF) band. Such frequencies are sometimes referred to as television white space (TVWS) frequencies.

In accordance with the present disclosure, a network of relay stations may be deployed throughout an area to be traveled by a mobile object such as a drone or other type of vehicle (e.g., satellite, balloon, self-driving car). The mobile object and the relay stations may be capable of communicating with each other via wireless links. For example, communication between the mobile object and the relay stations may occur via white space frequencies. Advantageously, the use of white space frequencies in the UHF or VHF band may enable long-range communication between a mobile object and a relay station.

Many jurisdictions have regulations that require an entity who is planning to use white space frequencies to periodically query a white space database to determine channel availability. Before departing on a predetermined route, a mobile object (or another entity on behalf of the mobile object) may query a database to determine what wireless channels are available for various locations along the route. When the mobile object moves within the communication range of a particular relay station, the mobile object may use one or more of the available channels in that location to communicate with the relay station. The mobile object may then send one or more messages to a remote system and/or receive one or more messages from the remote system via the relay station.

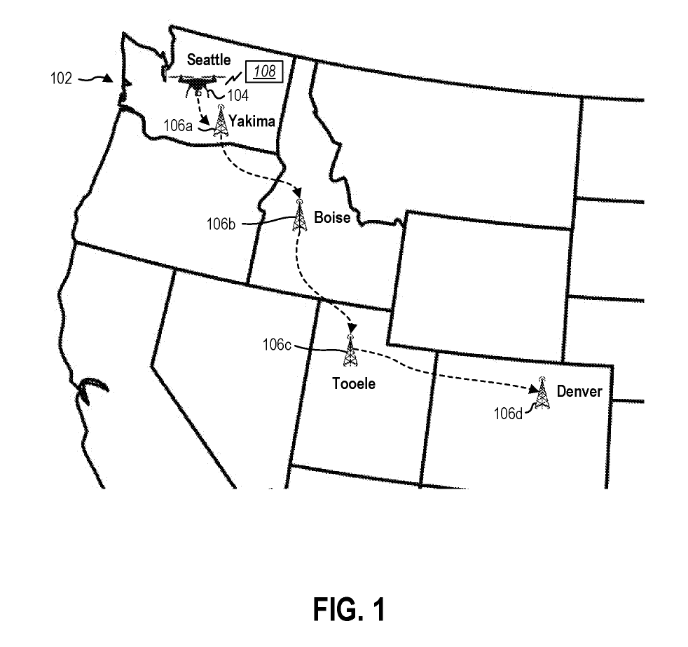

FIG. 1 illustrates an example of a route 102 to be traveled by a drone 104. In this example, the drone 104 is scheduled to travel across the northwestern part of the United States, taking off in Seattle and landing in Denver. On its way from Seattle to Denver, the drone 104 is scheduled to fly over several other cities including Yakima, Boise, and Tooele. A plurality of relay stations 106a-d are positioned along the route 102, including a relay station 106a in Yakima, a relay station 106b in Boise, a relay station 106c in Tooele, and a relay station 106d in Denver.

In the depicted example, the drone 104 begins its route 102 in Seattle, where it is in communication with a control system 108. Before taking off from Seattle, the drone 104 may obtain channel information indicating which long-range wireless channels are available in various locations along the route 102. For example, the drone 104 and the relay stations 106a-d may be configured to communicate with each other via white space frequencies, and the drone 104 (or another entity, such as the control system 108) may query a white space database to identify the white space channels that will be available in Yakima, Boise, Tooele, and Denver at the times when the drone 104 is scheduled to fly over these cities. (As used herein, the term “white space channels” refers to wireless communication channels in which transmission and reception of signals occur via white space frequencies.)

At some point after the drone 104 takes off from Seattle, it travels out of the communication range of the control system 108 and thus loses communication with the control system 108. When the drone 104 flies within the communication range of the relay station 106a in Yakima, the drone 104 may use one or more of the wireless channels (e.g., white space channels) that are available in Yakima at that time to re-establish communication with the control system 108 via the relay station 106a. While located within the communication range of the relay station 106a, the drone 104 may send one or more messages to the control system 108 and receive one or more messages from the control system 108 via the relay station 106a.

The drone 104 may lose communication with the control system 108 when the drone 104 flies away from Yakima and outside of the communication range of the relay station 106a located there. However, when the drone flies within the communication range of the relay station 106b located in Boise, the drone 104 may use one or more of the wireless channels (e.g., white space channels) that are available in Boise at that time to re-establish communication with the control system 108 via the relay station 106b.

A similar pattern may be repeated as the drone 104 continues along the route 102, moving from Boise to Tooele to Denver. The drone 104 may lose communication with the control system 108 when it leaves Boise, but the drone 104 may re-establish communication with the control system 108 when it reaches Tooele and is located within the communication range of the relay station 106c in Tooele. Similarly, the drone 104 may lose communication with the control system 108 when it leaves Tooele, but the drone 104 may re-establish communication with the control system 108 when it reaches Denver and is located within the communication range of the relay station 106d in Denver.

Thus, the techniques disclosed herein provide an inexpensive way to facilitate regular, frequent communication between a drone 104 and a control system 108. Instead of equipping the drone 104 with an expensive cellular or satellite radio, the drone 104 may include a relatively inexpensive radio that is capable of establishing long-range wireless links. For example, the drone 104 may include a radio (e.g., a TVWS radio) that is capable of communicating via white space frequencies (e.g., TVWS frequencies). The drone 104 may communicate with a network of relay stations 106a-d as it travels along a scheduled route 102, re-establishing communication with the control system 108 whenever it flies within the communication range of one of the relay stations 106a-d.

The relay network shown in FIG. 1 includes four relay stations 106a-d. However, the number of relay stations 106a-d shown in FIG. 1 is for purposes of example only, and should not be interpreted as limiting the scope of the present disclosure. In some implementations, a relay network may include a large number of relay stations such that a drone 104 is able to maintain continuous or near-continuous communication with the control system 108 as the drone 104 travels along the route 102.

Some of the relay stations 106a-d along the route 102 may be fixed, while other relay stations 106a-d may be temporary and/or mobile. In this context, a relay station may be considered to be “fixed” if it is installed or placed so that it is not easily movable. As will be discussed in greater detail below, under some circumstances a moving vehicle may serve as a relay station.

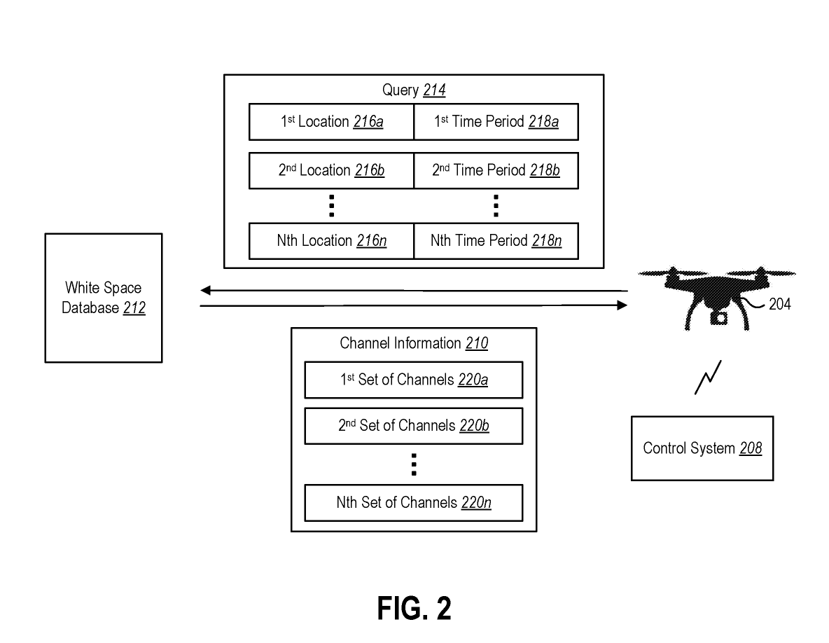

Reference is now made to FIG. 2. In some implementations, as indicated above, communication between a drone 204 and relay stations 106a-d within a relay network may occur via white space channels. Before the drone 204 departs from the starting point of a scheduled route 102, the drone 204 (or another entity acting on behalf of the drone 204, such as a control system 208) may query a white space database 212 to find out which white space channels are available in various locations along the route 102. FIG. 2 shows the drone 204 issuing a query 214 to a white space database 212 and obtaining channel information 210 in response to the query 214.

The query 214 may specify a plurality of locations 216a-n that the drone 204 is scheduled to travel along the route 102. For example, with respect to the route 102 shown in FIG. 1, the query 214 may specify Yakima, Boise, Tooele, and Denver. For each of these locations 216a-n, the query may also specify a corresponding time period 218a-n. Each time period 218a-n may include a date, a starting time, and an ending time. A time period 218a (e.g., “8:30-9:00 a.m. on Wednesday, May 16th”) corresponding to a particular location 216a (e.g., “Tooele”) may represent an estimate of when the drone 204 will be located within the communication range of a relay station in that location 216a.

The drone 204 may obtain channel information 210 in response to the query 214. The channel information 210 may indicate which wireless channels are available in the specified locations 216a-n during the specified time periods 218a-n. The channel information 210 may include multiple sets of channels 220a-n. A set of channels 220a may correspond to a particular location 216a and time period 218a, and may indicate one or more white space channels that are available in the specified location 216a during the specified time period 218a.

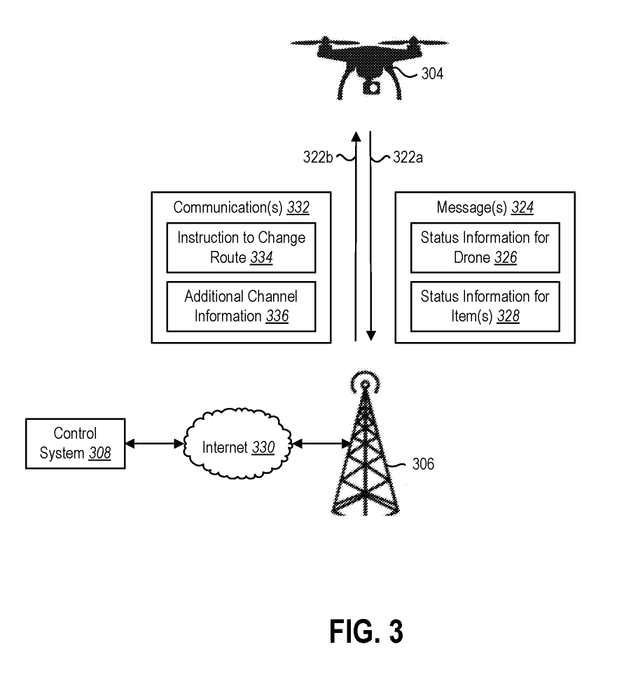

Reference is now made to FIG. 3. When a drone 304 flies within the communication range of a relay station 306 in a particular location, the drone 304 may use the channel information 210 it previously obtained to select one or more of the white space channels 322a-b that are available in that location to communicate with the relay station 306. In the example shown in FIG. 3, the channel information 210 indicates that at least two white space channels 322a-b are available during a time period when the drone 304 is scheduled to be within communication range of the relay station 306. The drone 304 selects a first white space channel 322a for downlink communications (i.e., communications from the drone 304 to the relay station 306), and a second white space channel 322b for uplink communications (i.e., communications from the relay station 306 to the drone 304).

The drone 304 may re-establish communication with a control system 308 via the relay station 306. For example, as shown in FIG. 3, the drone 304 may send one or more messages 324 to the control system 308 via the relay station 306. More specifically, the drone 304 may send the message(s) 324 to the relay station 306 via the downlink white space channel 322a, and the relay station 306 may forward the message(s) 324 to the control system 308 via a connection to the Internet 330. Thus, the control system 308 may receive message(s) 324 from the relay station 306 that originate with the drone 304.

The message(s) 324 may include status information 326 related to the drone 304 itself, such as alerts regarding malfunctioning components. The message(s) 324 may also include status information 328 related to one or more items being transported by the drone 304, such as the temperature (or other characteristics) of the item(s). The status information 326, 328 may be determined via one or more sensors that are included with the drone 304.

The drone 304 may also receive one or more communications 332 from the control system 308 via the relay station 306. The control system 308 may send the communication(s) 332 to the relay station 306 via the Internet 330, and the control system 308 may forward the communication(s) 332 to the drone 304 via the uplink white space channel 322b.

In some implementations, the control system 308 may send one or more communications 332 intended for the drone 304 to the relay station 306 before the drone 304 is within communication range of the relay station 306. The control system 308 may use the scheduled route 102 of the drone 304 to determine a time period during which the drone 304 is scheduled to be within communication range of the relay station 306. The control system 308 may send the communication(s) 332 to the relay station 306 before that time period, so that the relay station 306 has received the communication(s) 332 by the time the drone 304 has moved within communication range of the relay station 306.

The communication(s) 332 may include an instruction 334 to change the route 102 being traveled by the drone 304. For example, with respect to the route 102 shown in FIG. 1, the control system 308 may send a communication 332 to the relay station 106c in Tooele instructing the drone 304 to alter its route 102 so that the drone 304 travels from Tooele to another city (e.g., Phoenix) instead of Denver. When the drone 304 arrives in Tooele and receives the communication 332 from the relay station 106c, the drone 304 may alter its route 102 accordingly.

As another example, the control system 308 may send a communication 332 that includes additional channel information 336. The additional channel information 336 may be related to channels that are available in the current location of the drone 304, or to channels that are available in a subsequent location along the scheduled route 102. For example, referring again to the route 102 shown in FIG. 1, the control system 308 may send a communication 332 to the relay station 106b in Boise that includes information about available channels in Boise and/or in Tooele. If, for instance, there are multiple channels available in either of those cities, the control system 308 may send a communication 332 that indicates which of the available channels is preferred based on past performance.

The example shown in FIG. 3 illustrates two-way communication between the drone 304 and the control system 308. In an alternative implementation, only one-way communication may be established. For example, a drone 304 may use a white space channel 322a for downlink communications with a relay station 306 without establishing another channel for uplink communications.

Also, in the example shown in FIG. 3, the relay station 306 has a connection to the Internet 330. In some implementations, however, at least some of the relay stations 106a-d along the scheduled route 102 of the drone 304 may not be connected to the Internet 330.

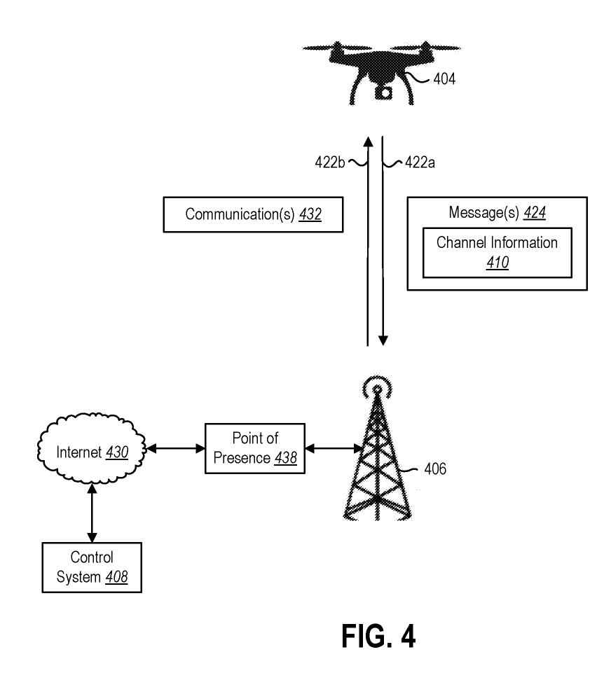

For example, referring to FIG. 4, a drone 404 may re-establish communication with a control system 408 via a relay station 406 that is not connected to the Internet 430. The relay station 406 may be capable of communicating with another entity, shown as a point of presence 438 in FIG. 4, that is connected to the Internet 430. Communication between the relay station 406 and the point of presence 438 may occur via a wireless connection or a wired connection.

If a relay station 406 is not connected to the Internet 430, communication between the drone 404 and the control system 408 may occur via both the relay station 406 and the point of presence 438. For example, the drone 404 may send one or more messages 424 that are intended for the control system 408 to the relay station 406 via the white space downlink channel 422a. The relay station 406 may forward the message(s) 424 to the point of presence 438, which may then send the message(s) 424 to the control system 408 via the Internet 430. Conversely, the control system 408 may send one or more communications 432 that are intended for the drone 404 to the point of presence 438 via the Internet 430. The point of presence 438 may forward the communication(s) 432 to the relay station 406, which may then send the communication(s) 432 to the drone 404 via the white space uplink channel 422b.

The message(s) 424 that the drone 404 sends to the relay station 406 may include any of the information discussed previously, such as status information 326 related to the drone 304 and/or status information 328 related to one or more items being transported by the drone 304. In addition, the message(s) 424 may also include channel information 410 indicating one or more available channels that the relay station 406 may use for communicating with the point of presence 438.

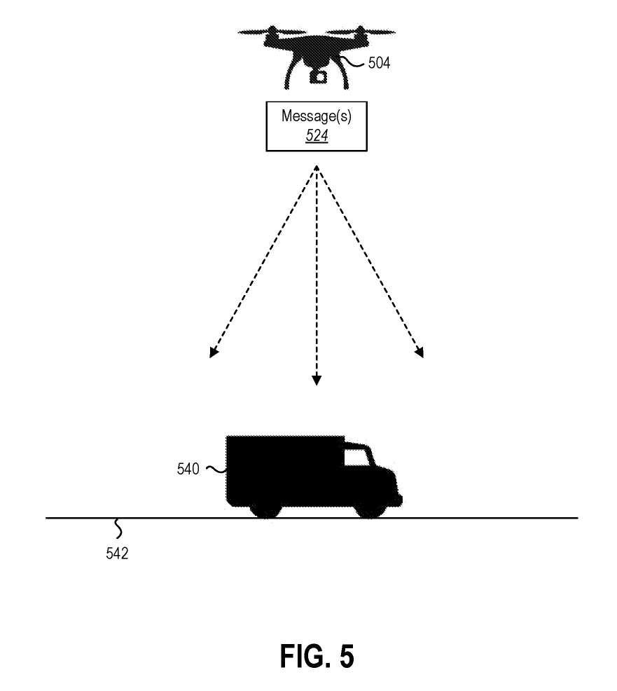

Reference is now made to FIG. 5. A drone 504 may fly over various sections of a scheduled route 102 that do not include any fixed relay stations. Under some circumstances, however, a moving vehicle 540 may function as a relay station.

To facilitate the use of moving vehicles 540 as relay stations, the route 102 for a drone 504 may be designed so that the drone 504 flies over one or more highways 542 in areas where there are not any fixed relay stations. Also, certain vehicles 540 may be equipped with a wireless interface (e.g., a TVWS radio) that is capable of establishing a long-range wireless link with the drone 504. For example, an entity may own a fleet of drones 504 and a fleet of vehicles 540, and may equip both with TVWS radios to facilitate communication between the drones 504 and the vehicles 540. Alternatively, the owner of a fleet of drones 504 may contract with the owner of a fleet of vehicles 540 to equip the vehicles 540 with TVWS radios.

When a drone 504 initially obtains channel information 210, the drone 504 may make a query 214 for the available channels along a section of a highway 542. As the drone 504 flies over the part of the route 102 that includes the section of the highway 542, the drone 504 may broadcast one or more messages 524 on an available channel. If a vehicle 540 that is capable of establishing a long-range wireless link with the drone 504 is traveling along the highway 542 when the drone 504 is flying over the highway 542, the vehicle 540 may receive the message(s) 524. If the vehicle 540 does not have an Internet connection when it is traveling along the highway 542, the vehicle 540 may store the message(s) 524 and forward them to the control system 108 at a later point in time when the vehicle 540 has Internet connectivity.

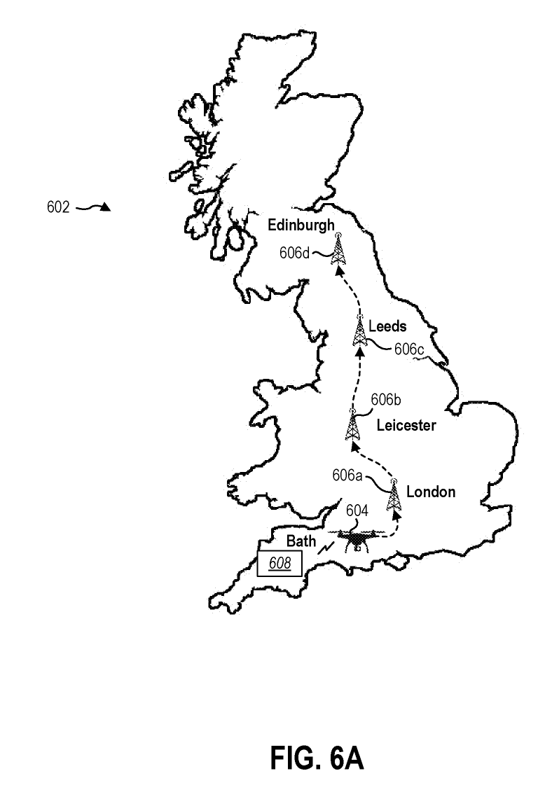

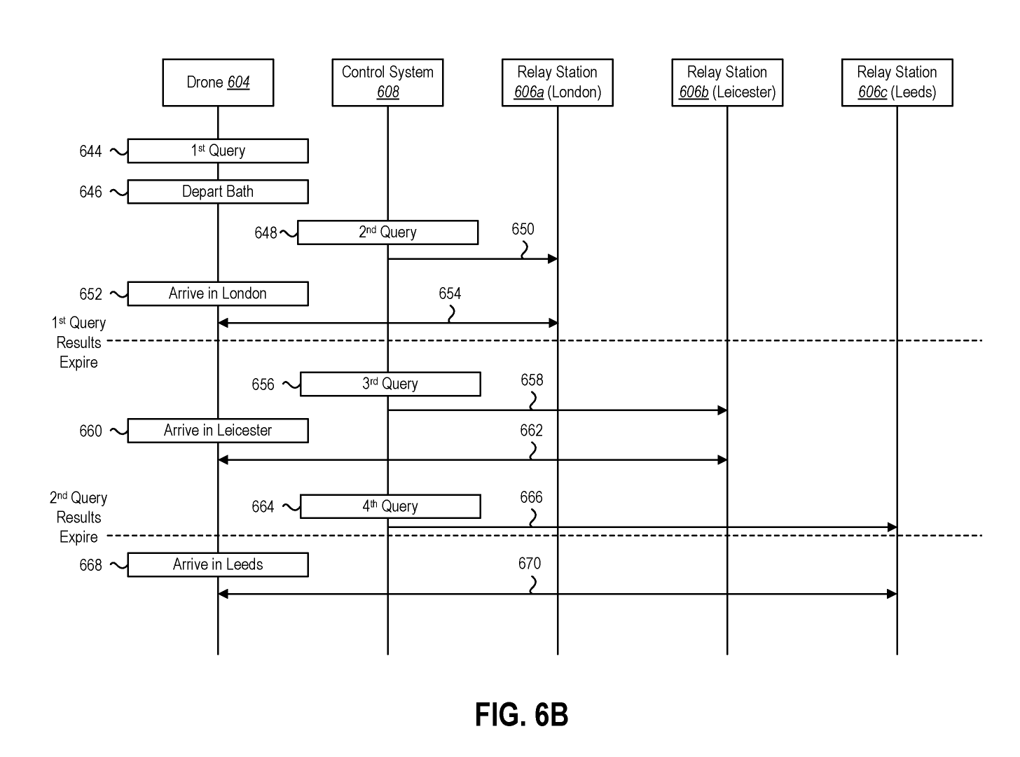

Reference is now made to FIG. 6A, which illustrates another example of a route 602 to be traveled by a drone 604. As indicated above, many jurisdictions have regulations that require an entity who is planning to use white space frequencies to periodically query a white space database 212 to determine channel availability. Some jurisdictions require these queries to occur quite frequently (e.g., every two hours). In cases where the drone 604 is scheduled to be in flight for a long period of time (e.g., more than two hours), the techniques disclosed herein make it possible to comply with regulatory requirements.

In the example shown in FIG. 6A, the drone 604 is scheduled to travel across the United Kingdom, taking off in Bath (where the drone 604 is in communication with a control system 608) and landing in Edinburgh. On the way from Bath to Edinburgh, the drone 604 is scheduled to fly over several other cities including London, Leicester, and Leeds. A plurality of relay stations 606a-d are positioned along the route 602, including a relay station 606a in London, a relay station 606b in Leicester, a relay station 606c in Leeds, and a relay station 606d in Edinburgh.

Reference is now made to FIG. 6B, which illustrates an example showing how the control system 608 may periodically query a white space database 212 on behalf of a drone 604 and communicate query results (including channel information 210) to the drone 604 using a network of relay stations 606a-d. In this example, the drone 604 begins the scheduled route 602 in Bath, where the drone 604 is in communication with the control system 608. Before taking off from Bath, the drone 604 (or another entity acting on behalf of the drone 604, such as the control system 608) may perform a first query 644 of a white space database 212 and determine channel information 210 indicating which white space channels are available in various locations along the route 602. The drone 604 may then depart 646 from Bath.

In the depicted example, it will be assumed that the first query results (i.e., the results obtained from performing the first query 644 of the white space database 212) will expire while the drone 604 is flying between London and Leicester. In other words, it will be assumed that there is a regulatory requirement to query the white space database 212 again before the drone 604 arrives 660 in Leicester. If no query is performed, then the channel information 210 for Leicester will be outdated when the drone 604 reaches Leicester.

To comply with the regulatory requirement, the control system 608 may perform a second query 648 of the white space database 212 while the drone 604 is flying from Bath to London. The control system 608 may then send 650 the second query results to the relay station 606a in London. The channel information 210 in the second query results may indicate the availability of wireless channels in (at least) Leicester. When the drone 604 arrives 652 in London, the drone 604 may communicate 654 with the relay station 606a and receive the channel information 210 for Leicester.

In this example, it will also be assumed that the second query results (i.e., the results obtained from performing the second query 648 of the white space database 212) will expire while the drone 604 is flying between Leicester and Leeds. To comply with the regulatory requirement discussed above, the control system 608 may perform a third query 656 of the white space database 212 while the drone 604 is flying from London to Leicester. The control system 608 may then send 658 the third query results, including channel information 210, to the relay station 606b in Leicester. The channel information 210 may indicate the availability of wireless channels in (at least) Leeds.

When the drone 604 arrives 660 in Leicester, the channel information 210 that the drone 604 has for Leicester is current because of the second query 648 that the control system 608 performed on behalf of the drone 604 while the drone 604 was flying from Bath to London. If the drone 604 were instead relying on the results of the first query 644, which was performed before the drone 604 departed 646 from Bath, then the channel information 210 would not be current because the first query results expired before the drone 604 arrived 660 in Leicester. The drone 604 received 654 the updated channel information 210 for Leicester from the relay station 606a in London.

While in Leicester, the drone 604 may communicate 662 with the relay station 606b and receive the updated channel information 210 for Leeds. As indicated above, the channel information 210 for Leeds may have previously been obtained via the third query 656 that the control system 608 performed on behalf of the drone 604 while the drone 604 was flying between London and Leicester. The third query 656 enables the drone 604 to have current channel information 210 for Leeds when the drone 604 arrives 668 there.

To enable the drone 604 to have current channel information 210 when it subsequently arrives in Edinburgh, the control system 608 may perform a fourth query 664 of the white space database 212 while the drone 604 is flying from Leicester to Leeds. The control system 608 may then send 666 the fourth query results, including channel information 210 for Edinburgh, to the relay station 606c in Leeds. When the drone 604 is in Leeds, the drone 604 may communicate 670 with the relay station 606c and receive the channel information 210 for Edinburgh.

The example shown in FIGS. 6A-B illustrates how a drone 604 may periodically receive communications from the control system 608 via relay stations 606a-d as the drone 604 travels along the route 602. The communications may include updated channel information obtained from queries 648, 656, 664 performed by the control system 608. In other words, the control system 608 may periodically query a white space database 212 on behalf of the drone 604 and send channel information 210 to relay stations 606a-d as the drone 604 travels along the route 602. The queries 648, 656, 664 may be predictive, in that the control system 608 may time the queries 648, 656, 664 to comply with one or more regulatory requirements based on when the drone 604 is predicted to be in particular locations.

In the depicted example, the control system 608 performs the queries 648, 656, 664 on behalf of the drone 604. In an alternative implementation, however, the drone 604 itself may perform at least some of the queries 648, 656, 664. This may occur, for example, if the communication range of the relay stations 606a-d is large enough that the drone 604 has time to perform the queries 648, 656, 664 as it travels along the scheduled route 602. In other words, if the drone 604 is able to stay in communication with the relay stations 606a-d for a sufficiently long period of time to query the white space database 212, then the drone may perform the queries 648, 656, 664.

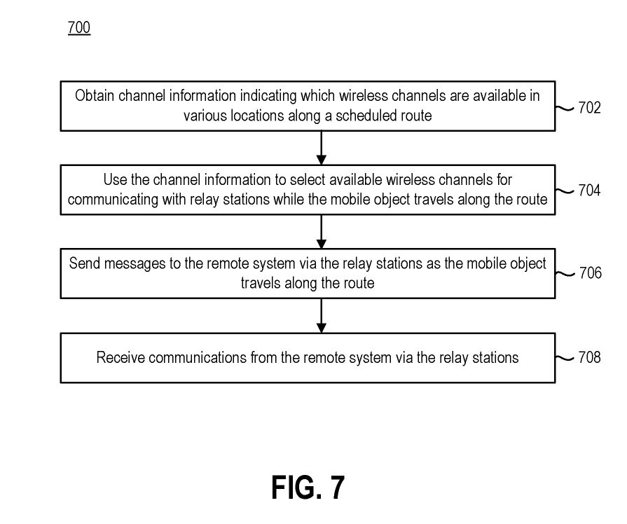

FIG. 7 illustrates a method 700 that may be implemented by a mobile object (such as a drone 104) to facilitate regular communication between the mobile object and a remote system (such as a control system 108). Before departing on a scheduled route 102, the mobile object (or another entity on behalf of the mobile object) may obtain 702 channel information 210 indicating which long-range wireless channels are available in various locations along the route 102. The channels may be white space channels, and the channel information may be obtained 702 by querying a white space database 212.

The mobile object may use the channel information 210 to select 704 available wireless channels for communicating with relay stations 106a-d while the mobile object travels along the route 102. By using the available wireless channels to communicate with the relay stations 106a-d, the mobile object may send 706 messages 324 to the remote system via the relay stations 106a-d as the mobile object travels along the route 102. The mobile object may also receive 708 communications 332 from the remote system via the relay stations 106a-d.

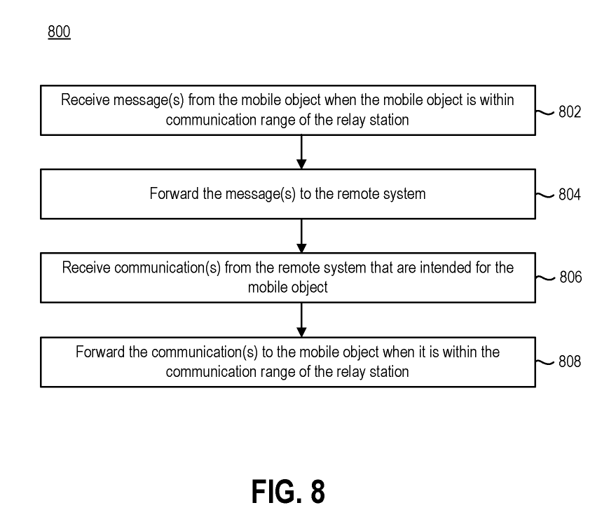

FIG. 8 illustrates a method 800 that may be implemented by a relay station 306 to facilitate regular communication between a mobile object (such as a drone 304) and a remote system (such as a control system 308). The relay station 306 may receive 802 one or more messages 324 from the mobile object when the mobile object is within communication range of the relay station 306. Communication between the mobile object and the relay station 306 may occur via one or more long-range wireless channels (e.g., white space channels 322a-b) that are available in the location of the relay station 306. The relay station 306 may forward 804 the message(s) 324 it receives from the mobile object to the remote system, either via a connection to the Internet 330 or via a separate point of presence 438 that is connected to the Internet 330.

The relay station 306 may also receive 806 one or more communications 332 from the remote system that are intended for the mobile object. The communication(s) 332 may be received either via a connection to the Internet 330 or via a separate point of presence 438 that is connected to the Internet 330. The relay station 306 may forward 808 the communication(s) 332 to the mobile object when the mobile object is within the communication range of the relay station 306.

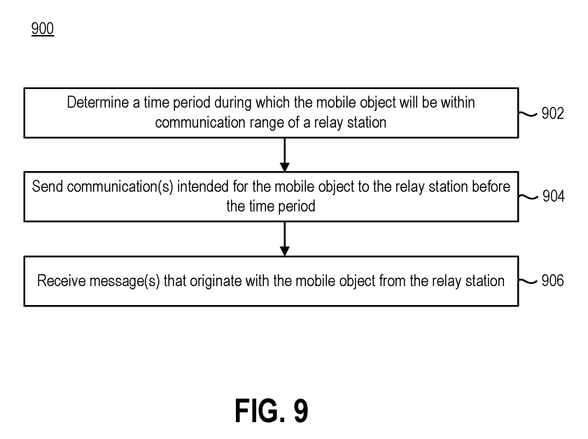

FIG. 9 illustrates a method 900 that may be implemented by a remote system (such as a control system 308) to facilitate communication between a mobile object (such as a drone 304) and the remote system. The remote system may determine 902, based on a scheduled route 102 for the mobile object, a time period during which the mobile object will be within the communication range of a relay station 306. The remote system may send 904 at least one communication 332 that is intended for the mobile object to the relay station 306. The communication(s) 332 may be sent 904 before the time period, so that the relay station 306 has received the communication(s) 332 when the mobile object is within the communication range of the relay station 306. The remote system may also receive 906 one or more message(s) 324 that originate with the mobile object from the relay station 306.

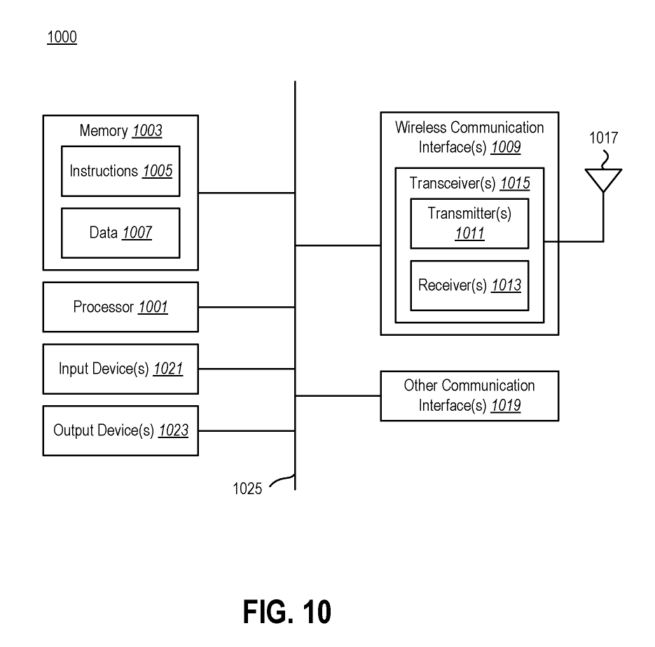

FIG. 10 illustrates certain components that may be included within a computer system 1000. One or more computer systems 1000 may be used to implement at least some of the devices, components, and systems described herein, such as the control systems 108, 208, 308, 408, the relay stations 106a-d, 306, 406, 606a-d, and the point of presence 438.

The computer system 1000 includes a processor 1001. The processor 1001 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1001 may be referred to as a central processing unit (CPU). Although just a single processor 1001 is shown in the computer system 1000 of FIG. 10, in an alternative configuration, a combination of processors (e.g., an ARM and DSP) could be used.

The computer system 1000 also includes memory 1003. The memory 1003 may be any electronic component capable of storing electronic information. For example, the memory 1003 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 1005 and data 1007 may be stored in the memory 1003. The instructions 1005 may be executable by the processor 1001 to implement some or all of the functionality disclosed herein, including the methods 700, 800, 900 shown in FIGS. 7-9. Executing the instructions 1005 may involve the use of the data 1007 that is stored in the memory 1003. Any of the various examples of modules and components described herein may be implemented, partially or wholly, as instructions 1005 stored in memory 1003 and executed by the processor 1001. Any of the various examples of data described herein may be among the data 1007 that is stored in memory 1003 and used during execution of the instructions 1005 by the processor 1001.

The computer system 1000 may include one or more wireless communication interfaces 1009. The wireless communication interface(s) 1009 may include at least one transceiver 1015, and each transceiver 1015 may include at least one transmitter 1011 and at least one receiver 1013. Each transceiver 1015 may allow transmission and reception of signals between the computer system 1000 and other devices. One or more antennas 1017 may be electrically coupled to the transceiver(s) 1015. In some implementations, at least one wireless communication interface 1009 may be configured so that transmission and reception of signals occurs via white space frequencies.

The computer system 1000 may also include one or more other communication interfaces 1019, which may be based on wired communication technology. Some examples of other communication interfaces 1019 that may be included in the computer system 1000 include a Universal Serial Bus (USB) and an Ethernet adapter.

A computer system 1000 may also include one or more input devices 1021 and one or more output devices 1023. Some examples of input devices 1021 include a keyboard, mouse, microphone, remote control device, button, joystick, trackball, touchpad, and lightpen. Some examples of output devices 1023 include a display device, a speaker, and a printer.

The various components of the computer system 1000 may be coupled together by one or more buses, which may include a power bus, a control signal bus, a status signal bus, a data bus, etc. For the sake of clarity, the various buses are illustrated in FIG. 10 as a bus system 1025.

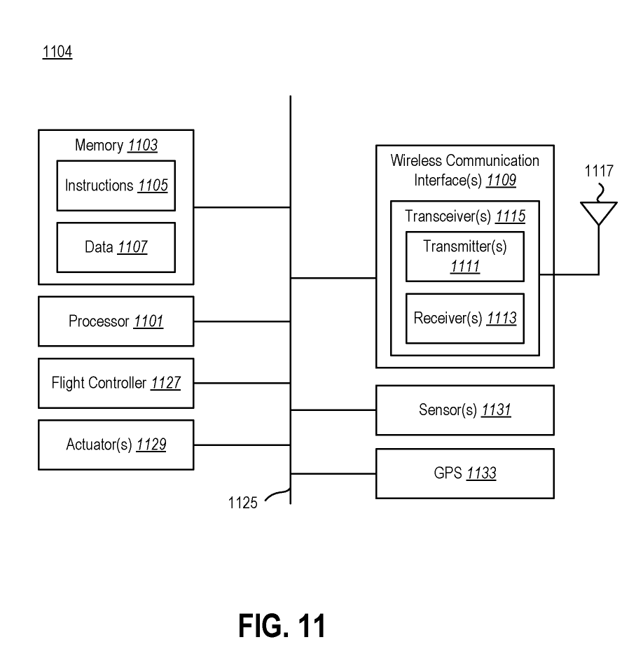

FIG. 11 illustrates certain components that may be included within a mobile object 1104, such as a drone. Any of the drones 104, 204, 304, 404, 504, 604 described herein may include some or all of the components shown in FIG. 11.

The mobile object 1104 may include certain components that are similar to corresponding components in the computer system 1000 of FIG. 10, including a processor 1101, memory 1103, instructions 1105 and data 1107 stored in the memory 1103, at least one wireless communication interface 1109 (which may include one or more transceivers 1115, with each transceiver 1115 including at least one transmitter 1111, at least one receiver 1113, and at least one antenna 1117), and a bus system 1125.

If the mobile object 1104 is capable of flight, the mobile object 1104 may include a flight controller 1127 that controls the mobile object 1104 and causes the mobile object 1104 to fly along a scheduled route 102. The mobile object 1104 may also include one or more actuators 1129, which may take the form of digital electronic speed controllers. One or more actuators 1129 may be linked to components such as motors/engines, propellers, and servomotors. The mobile object 1104 may also include one or more sensors 1131. The sensors 1131 may include position and movement sensors that provide information about the state of the mobile object 1104 itself. The sensors 1131 may also include sensors that provide information about one or more items being carried by the mobile object 1104. The mobile object 1104 may also include a Global Positioning System (GPS) 1133 that enables the mobile object 1104 to determine its location.

In accordance with an aspect of the present disclosure, a mobile object is disclosed that is configured to communicate with a remote system. The mobile object may include a wireless communication interface, a processor, memory in electronic communication with the processor, and instructions stored in the memory. The instructions may be executable by the processor to obtain channel information indicating which wireless channels are available in a plurality of locations along a route to be traveled by the mobile object, use the channel information to select one or more available wireless channels for communicating with at least one relay station while the mobile object travels along the route, and send one or more messages to the remote system via the at least one relay station. Wireless communication between the mobile object and the at least one relay station may occur via the one or more available wireless channels.

The mobile object may include a done. The remote system may include a control system for the drone.

The one or more messages may include at least one of status information related to the mobile object or status information related to an item being transported by the mobile object.

The instructions may also be executable to receive one or more communications from the remote system via the at least one relay station while the mobile object travels along the route.

The one or more communications from the remote system may include at least one of an instruction to change the route that is traveled by the mobile object or additional channel information.

The instructions may also be executable to periodically receive communications from the remote system via relay stations as the mobile object travels along the route. The communications may include additional channel information obtained from queries performed by the remote system. The queries may be timed to comply with one or more regulatory requirements.

The channel information may indicate an available channel corresponding to a part of the route that does not include any fixed relay stations but does include a section of a highway. The instructions may also be executable to broadcast a message on the available channel when the mobile object travels along the part of the route that includes the section of the highway.

The wireless communication interface may be configured to transmit and receive signals via white space frequencies. The one or more available wireless channels may be white space channels.

In accordance with another aspect of the present disclosure, a method for facilitating communication between a mobile object and a remote system is disclosed. The method may be implemented by a relay station. The method may include receiving one or more messages from the mobile object when the mobile object is within communication range of the relay station, forwarding the one or more messages to the remote system, receiving one or more communications that are intended for the mobile object, and forwarding the one or more communications to the mobile object when the mobile object is within the communication range of the relay station. The one or more communications may be received from the remote system.

The mobile object may include a drone. The remote system may include a control system for the drone.

The relay station may have an Internet connection. Forwarding the one or more messages to the remote system may include sending the one or more messages to the remote system via the Internet connection.

The relay station may not have Internet connectivity. Forwarding the one or more messages to the remote system may include forwarding the one or more messages to a separate point of presence that has an Internet connection.

The method may further include receiving channel information from the mobile object. The channel information may indicate an available channel to use for communicating with the point of presence.

One or more messages received from the mobile object may include at least one of status information related to the mobile object or status information related to an item being transported by the mobile object.

The one or more communications that are intended for the mobile object may include at least one of an instruction to change a scheduled route that is traveled by the mobile object or channel information related to one or more channels that the mobile object uses to communicate with at least one relay station while the mobile object travels along the scheduled route.

In accordance with another aspect of the present disclosure, a method for facilitating regular communication between a mobile object and a remote system is disclosed. The method may be implemented by the remote system. The method may include determining, based on a scheduled route for the mobile object, a time period during which the mobile object will be within communication range of a relay station. The method may also include sending at least one communication to the relay station before the time period. The at least one communication may be intended for the mobile object. The method may also include receiving one or more messages from the relay station. The one or more messages may originate with the mobile object.

The mobile object may include a drone. The remote system may include a control system for the drone.

The at least one communication that is intended for the mobile object may include at least one of an instruction to change the scheduled route of the mobile object or channel information related to one or more channels that the mobile object uses to communicate with at least one relay station while the mobile object travels along the scheduled route.

The one or more messages received from the relay station and originating with the mobile object may include at least one of status information related to the mobile object or status information related to an item being transported by the mobile object.

The method may further include periodically querying a database and sending channel information to relay stations as the mobile object travels along the scheduled route. The querying may be timed to comply with one or more regulatory requirements.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A mobile object comprising:
a wireless communication interface;
a processor; and
a memory in communication with the processor, the memory comprising executable instructions that, when executed by the processor, cause the processor to control the mobile object to perform functions of:
obtaining channel information including a plurality of wireless channels available in a plurality of locations along a route to be traveled by the mobile object;
using the channel information, selecting, from the plurality of available wireless channels, a wireless channel for communicating with a relay station while the mobile object travels along the route; and
sending a message to the remote system via the relay station, wherein wireless communication between the mobile object and the relay station occurs via the selected wireless channel.

2. The mobile object of claim 1, wherein:
the mobile object comprises a drone; and
the remote system comprises a control system for the drone.

3. The mobile object of claim 1, wherein the message comprises at least one of:
status information related to the mobile object; and
status information related to an item being transported by the mobile object.

4. The mobile object of claim 1, wherein the instructions, when executed by the processor, further cause the processor to control the mobile object to perform a function of receiving a communication from the remote system via the relay station while the mobile object travels along the route.

5. The mobile object of claim 4, wherein the communication received from the remote system comprises at least one of:
an instruction to change the route that is traveled by the mobile object; and
additional channel information.

6. The mobile object of claim 1, wherein the instructions, when executed by the processor, further cause the processor to control the mobile object to perform a function of periodically receiving communications from the remote system via a plurality of relay stations as the mobile object travels along the route, the communications comprising additional channel information obtained from queries performed by the remote system, the queries being timed to comply with a regulatory requirement.

7. The mobile object of claim 1, wherein the plurality of available wireless channels includes a first channel corresponding to a part of the route including a section of a highway, and
the instructions, when executed by the processor, further cause the processor to control the mobile object to perform a function of broadcasting a message on the first channel when the mobile object travels along the part of the route that includes the section of the highway.

8. The mobile object of claim 1, wherein:
the wireless communication interface is configured to transmit and receive a signal via a white space frequency; and
the plurality of available wireless channels includes a white space frequency channel.

9-20. (canceled)

21. A method of operating a mobile object, comprising:
obtaining channel information including a plurality of wireless channels available in a plurality of locations along a route to be traveled by the mobile object;
using the channel information, selecting, from the plurality of available wireless channels, a wireless channel for communicating with a relay station while the mobile object travels along the route; and
sending a message to the remote system via the relay station, wherein wireless communication between the mobile object and the relay station occurs via the selected wireless channel.

22. The method of claim 21, wherein:
the mobile object comprises a drone; and
the remote system comprises a control system for the drone.

23. The method of claim 21, wherein the message comprises at least one of:
status information related to the mobile object; and
status information related to an item being transported by the mobile object.

24. The method of claim 21, further comprising receiving a communication from the remote system via the relay station while the mobile object travels along the route.

25. The method of claim 24, wherein the communication received from the remote system comprises at least one of:
an instruction to change the route that is traveled by the mobile object; and
additional channel information.

26. The method of claim 21, further comprising periodically receiving communications from the remote system via a plurality of relay stations as the mobile object travels along the route, the communications comprising additional channel information obtained from queries performed by the remote system, the queries being timed to comply with a regulatory requirement.

27. The method of claim 21, wherein the plurality of available wireless channels includes a first channel corresponding to a part of the route including a section of a highway, and
the method further comprises broadcasting a message on the first channel when the mobile object travels along the part of the route that includes the section of the highway.

28. The method of claim 21, wherein the plurality of available wireless channels includes a white space frequency channel.

29. A non-transitory computer readable medium containing instructions which, when executed by a processor, cause a mobile object to perform functions of:
obtaining channel information including a plurality of wireless channels available in a plurality of locations along a route to be traveled by the mobile object;
using the channel information, selecting, from the plurality of available wireless channels, a wireless channel for communicating with a relay station while the mobile object travels along the route; and
sending a message to the remote system via the relay station, wherein wireless communication between the mobile object and the relay station occurs via the selected wireless channel.

30. The non-transitory computer readable medium of claim 29, wherein the message comprises at least one of:
status information related to the mobile object; and
status information related to an item being transported by the mobile object.

31. The method of claim 29, wherein the instructions, when executed by the processor, further cause the mobile object to perform a function of receiving a communication from the remote system via the relay station while the mobile object travels along the route.

32. The method of claim 31, wherein the communication received from the remote system comprises at least one of:
an instruction to change the route that is traveled by the mobile object; and
additional channel information.
